(19) United States
(12) Patent Application Publication
(10) Pub. No.: US 2007/0197388 A1
(43) Pub. Date: Aug. 23, 2007

(54) Haloperoxidase treatment to control algae

(75) Inventors: Graciela H. Vunk, Olive Branch, MS (US); Deborah A. Marais, Lakeland, TN (US)

Correspondence Address: KILYK & BOWERSOX, P.L.L.C., 400 HOLIDAY COURT, SUITE 102, WARRENTON, VA, 20186, US

(73) Assignee: Buckman Laboratories International, Inc.

(21) Appl. No.: 11/359,022

(22) Filed: Feb. 22, 2006

(51) Int. Cl. A01N 59/00

(52) U.S. Cl. 504/150; 424/94.4

(57) ABSTRACT

A method for killing, preventing, or inhibiting the growth of algae in an aqueous system is provided by providing a haloperoxidase, and hydrogen peroxide or a peroxide source to a chlorinated water system under conditions in which the haloperoxidase, peroxide from the hydrogen peroxide or peroxide source, and chloride ions or chloroamines in the chlorinated water system interact to provide an antialgal agent.

### FIELD OF THE INVENTION

The present invention relates to a composition and method of treatment with haloperoxidase to control algae.

### BACKGROUND OF THE INVENTION

Chlorine is the sanitizer/disinfectant/oxidizer most widely used by pool owners. It is very effective at killing bacteria, algae, and other living organisms. Chlorine is typically added to a swimming pool in tablet or liquid form or is provided by a chlorine generator, which is a device containing electrical cells that generate chlorine from a bank of salt added to the pool water. Current saline swimming pool systems have salinity levels between 2800 and 4000 ppm of sodium chloride. After being depleted, the free available chlorine (FAC) reverts back to salt to be reused.

However, chlorine has many disadvantages that lessen its desirability for use as an exclusive disinfectant in swimming pools and other recreational water systems. For example, chlorine can combine with ammonia to form chloramines, which are ineffective at sanitizing, disinfecting, or oxidizing. Ammonia is commonly present in pool water from either environmental factors, a build up of fertilizers that are carried by wind and dropped into pools, from swimmer wastes (perspiration, urine, saliva and body oils), or even from some suntan lotions. As a consequence, pool managers often over-chlorinate a pool (>3 ppm) to compensate for the ineffectiveness of chloramines. Over-chlorination can lead to excessive absorption of chlorine and chloramines through the skin or to inhalation of air or water vapor containing chlorine and chloramines. Athletes who train for many hours in a swimming pool, particularly in an indoor environment, may be particularly susceptible to over-exposure to chlorine and chloramines and may exhibit symptoms of hypersensitivity and asthma-like respiratory conditions.

Haloperoxidases are enzymes that catalyze oxidation reactions while consuming hydrogen peroxide or other oxidative agents. An electron donor (reducing agent) is generally used for the oxidation reaction to go forward. In the presence of a halide as an electron donor, a haloperoxidase system can generate products that possess biocidal properties.

U.S. Pat. No. 5,451,402 to Allen describes a method for killing yeast and sporular microorganisms with haloperoxidase-containing compositions said to be useful in therapeutic antiseptic treatment of human or animal subjects and in vitro applications for disinfection or sterilization of vegetative microorganisms and fungal spores.

U.S. Patent Application Publication No. 2002/0119136 A1 to Johansen relates to an antimicrobial composition containing a Coprinus peroxidase, hydrogen peroxide, and an enhancing agent such as an electron donor. The composition is said to be useful for inhibiting or killing microorganisms present in laundry, on human or animal skin, hair, mucous membranes, oral cavities, teeth, wounds, bruises, and on hard surfaces. Also the composition can be used as a preservative for cosmetics, and for cleaning, disinfecting, or inhibiting microbial growth on process equipment used for water treatment, food processing, chemical or pharmaceutical processing, paper pulp processing, and water sanitation.

U.S. Pat. No. 6,251,386 and U.S. Pat. No. 6,818,212 B2 to Johansen relate to an antimicrobial composition containing a haloperoxidase, a hydrogen peroxide source, a halide source and an ammonium source and a method of use of the antimicrobial composition for killing or inhibiting the growth of microorganisms. The patents also describe that there is an unknown synergistic effect between halide and the ammonium source.

U.S. Pat. No. 6,149,908 to Claesson et al. relates to the use of lactoperoxidase, a peroxide donor, and thiocyanate for the manufacture of a medicament for treating Helicobacter pylori infection.

U.S. Pat. No. 5,607,681 to Galley et al. describes antimicrobial compositions containing iodide or thiocyanate anions, glucose oxidase and D-glucose, and lactoperoxidase. The patent states that compositions may be provided in concentrated non-reacting forms such as dry powders and non-aqueous solutions. The compositions are mentioned as being useful as preservatives or as active agents providing potent antimicrobial activity of use in oral hygiene, deodorant and anti-dandruff products.

U.S. Pat. No. 5,250,299 to Good et al. relates to a synergistic antimicrobial composition composed of a hypothiocyanate generating system adjusted to a pH between about 1.5 and about 5 with a di or tricarboxylic acid. The hypothiocyanate generating system is composed of lactoperoxidase, a thiocyanate and hydrogen peroxide. The patent describes a method of disinfecting surfaces associated with food preparations, and a method of killing Salmonella on poultry and other Gram negative microorganisms contaminating the surfaces of food products.

U.S. Pat. No. 5,176,899 to Montgomery describes a stabilized aqueous antimicrobial dentifrice composition containing an oxidoreductase enzyme and its specific substrate for producing hydrogen peroxide, a peroxidase acting on the hydrogen peroxide for oxidizing thiocyanate ions contained in saliva to produce antimicrobial concentrations of hypothiocyanite ions.

International Publication No. WO 98/49272 by Guthrie et al. (Knoll Aktiengesellschaft) relates to a stabilized aqueous antimicrobial enzyme composition containing lactoperoxidase, glucose oxidase, alkali metal halide salt, and a chelating buffering agent giving the composition a specified pH. The composition is described as being useful as an antimicrobial agent used in milk products, foodstuffs, and pharmaceuticals.

U.S. Pat. No. 5,043,176 to Bycroft et al. relates to a synergistic antimicrobial composition composed of an antimicrobial polypeptide and a hypothiocyanate component. Synergistic activity is seen when the composition is applied at between about 30 and 40° C. at a pH between about 3 and about 5. The composition is said to be useful against gram negative bacteria such as Salmonella. A preferred composition is nisin, lactoperoxidase, thiocyanate, and hydrogen peroxide. It is stated that the composition is capable of reducing the viable cell count of Salmonella by greater than 6 logs in 10 to 20 minutes.

U.S. Pat. No. 4,937,072 to Kessler et al. describes an in situ sporicidal disinfectant comprising a peroxidase, a peroxide, or peroxide generating materials, and a salt of iodide. The three components are stored in a non-reacting state to maintain the sporocide in an inactive state. Mixing the three components in an aqueous carrier causes a catalyzed reaction with peroxidase to generate antimicrobial free radicals and/or byproducts.

Because of the above-mentioned disadvantages of chlorine in recreational water systems, it is desirable to have a method of preventing, killing, and/or inhibiting the growth of algae in a recreational water system that allows for the use of chlorine to be minimized.

It is also desirable to have a method of preventing, killing, and/or inhibiting the growth of algae that is inexpensive and preferably uses a composition that is effective at a low concentration and that uses easily available ingredients.

It is also desirable to have a method of preventing, killing, and/or inhibiting the growth of algae in a recreational water system that makes use of chloramines that are incidentally produced as a result of a chlorine treatment.

It is also desirable to have a method of preventing, killing, and/or inhibiting the growth of algae in a recreational water system that makes use of a chloride ion level that is present in a recreational water system that uses a chlorine generator.

### SUMMARY OF THE INVENTION

It has now been found that a potent antialgal solution to control the growth of algae in aqueous systems and on substrates capable of supporting such growth may be obtained by providing haloperoxidase, hydrogen peroxide or a peroxide source such as percarbonate or enzymatic peroxide generating system such as a glucose oxidase/glucose system (GO/glu), a halide source, and, optionally, an ammonium source, under conditions wherein the haloperoxidase, peroxide from the hydrogen peroxide or peroxide source, halide source and ammonium, if present, interact to provide an antialgal agent to the aqueous system or substrate. The individual components may be pre-mixed to form a solution in water, wherein the components interact to form an antialgal agent, and the resulting solution may then be applied in an effective amount to aqueous systems, other systems, or substrates to be treated. Alternatively, the individual components may be added separately (or in any combination) to the aqueous system, other systems, or substrates to be treated, and the concentration of each component can be selected so that an active antialgal composition is formed in situ and maintained for a desired period of time in the aqueous systems, other systems, or on a substrate to be treated.

The present invention further provides a composition comprising haloperoxidase, hydrogen peroxide or a peroxide source such as carbamide peroxide, percarbonate, perborate or persulfate or an enzymatic peroxide generating system such as a glucose oxidase/glucose system (GO/glu), a halide, and, optionally, an ammonium source.

The present invention further provides an all-solid composition that contains at least a solid mixture of haloperoxidase, an ammonium halide, and an enzyme substrate, such as glucose, of an enzyme peroxide generating system in one water-soluble container, and a solid peroxide-generating enzyme, such as glucose oxidase, in another water-soluble container. In a further method of the present invention, a potent antialgal solution may be formed by dissolving all of the solids in the above two water-soluble containers in a desirable amount of water. The resulting solution may then be applied in an effective amount to the systems or substrates to be treated. Alternatively, the contents in the above two water-soluble containers may be dissolved separately in water to form two separate concentrated solutions, one solution containing at least haloperoxidase, ammonium halide, such as ammonium bromide, and glucose, and the other solution containing at least glucose oxidase. The resulting solutions may then be added separately in an effective amount to the systems or substrates to be treated, wherein the solutions interact in the aqueous system to form the antialgal composition.

The haloperoxidase system described herein generates a potent antialgal composition that is preferably much stronger than hydrogen peroxide acting alone.

It has further been found that a potent antialgal solution to control the growth of algae in a chlorinated water system may be obtained by providing haloperoxidase and hydrogen peroxide or a peroxide source such as percarbonate or enzymatic peroxide generating system such as a glucose oxidase/glucose system (GO/glu), to a chlorinated water system under conditions wherein the haloperoxidase and peroxide from the hydrogen peroxide or peroxide source preferably interact with chloride ions or chloramines in the chlorinated water system to provide an antialgal agent to the chlorinated water system. The haloperoxidase and hydrogen peroxide or peroxide source may be pre-mixed to form a solution in water, and the resulting solution may then be applied in an effective amount to the chlorinated water system. Alternatively, the haloperoxidase and hydrogen peroxide or peroxide source components may be added separately, in any order, (or in any combination) to the chlorinated water system.

The methods and compositions described herein can be applied in a variety of industrial fluid systems (e.g., aqueous systems) and processes, including, but not limited to, paper-making water systems, pulp slurries, white water in paper-making process, cooling water systems (cooling towers, intake cooling waters and effluent cooling waters), waste water systems, recirculating water systems, hot tubs, swimming pools, recreational water systems, food processing systems, drinking water systems, leather-processing water systems, metal working fluids, and other industrial water systems. The method described herein may also be applied to control the growth of algae on various substrates, including, but not limited to, surface coatings, metals, polymeric materials, natural substrates (e.g., stone), masonry, concrete, wood, paint, seeds, plants, animal hides, plastics, cosmetics, personal care products, pharmaceutical preparations, and other industrial materials.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

It is to be understood that both the foregoing general description and the following detailed description are exemplary only and are not restrictive of the present invention, as claimed. All patents, patent applications, and publications mentioned above and throughout the present application are incorporated in their entirety by reference herein.

### DETAILED DESCRIPTION OF THE PRESENT INVENTION

The present invention provides methods and compositions for controlling the growth of algae in aqueous systems or on substrates using a) haloperoxidase, b) hydrogen peroxide or a hydrogen peroxide source, and c) a halide, plus, optionally, an ammonium source like a salt. The halide and the ammonium source may both be provided in the form of a salt containing both ammonium and a halide, such as ammonium bromide or a quaternary ammonium compound. For instance, the combination of haloperoxidase, hydrogen peroxide, and a halide, or the combination of haloperoxidase, hydrogen peroxide, a halide and an ammonium salt, forms a strong antialgal composition that is preferably much more active than hydrogen peroxide working alone. The present invention provides a method for controlling the growth of algae in or on a product, material, or medium susceptible to supporting growth of algae. This method includes the step of adding to the product, material, or medium a composition of the present invention in an amount effective to control the growth of algae. The effective amount varies in accordance with the product, material, or medium to be treated and can, for a particular application, be routinely determined by one skilled in the art in view of the disclosure provided herein. The compositions of the present invention are useful in preserving or controlling the growth of algae in various types of industrial products, media, or materials susceptible to attack by algae. Such media or materials include, but are not limited to, for example, dyes, pastes, lumber, leathers, textiles, pulp, wood chips, tanning liquor, paper mill liquor, polymer emulsions, paints, paper and other coating and sizing agents, metalworking fluids, geological drilling lubricants, petrochemicals, cooling water systems, recreational water, influent plant water, waste water, pasteurizers, retort cookers, pharmaceutical formulations, cosmetic formulations, and toiletry formulations. The composition can also be useful in agrochemical formulations for the purpose of protecting seeds or crops against algal spoilage.

The compositions of the present invention can be used in a method for controlling the growth of algae in or on a product, material, or medium susceptible to attack by algae. This method includes the step of adding to the product, material, or medium a composition of the present invention, where the components of the composition are present in effective amounts to control the growth of algae.

As stated earlier, the compositions of the present invention are useful in preserving various types of industrial products, media, or materials susceptible to attack by algae. The compositions of the present invention are also useful in agrochemical formulations for the purpose of protecting seeds or crops against algal spoilage. These methods of preserving and protecting are accomplished by adding the composition of the present invention to the products, media, or materials in an amount effective to preserve the products, media, or materials from attack by algae or to effectively protect the seeds or crops against algal spoilage. According to the methods of the present invention, controlling or inhibiting the growth of algae includes the reduction and/or the prevention of such growth.

It is to be further understood that by “controlling” (e.g., preventing) the growth of algae, the growth of algae is at least partially inhibited. In other words, there is preferably no growth or essentially no growth of algae. “Controlling” the growth of algae maintains the microorganism population at a desired level, reduces the population to a desired level (even to undetectable limits), and/or inhibits the growth of algae.

Although a haloperoxidase has no antialgal activity by itself, in the presence of H₂O₂, it catalyzes the oxidation of Cl⁻ or other halides to generate antialgal products through the generation of oxidation products, such as the hypochloride. Haloperoxidase antialgal systems require very low levels of H₂O₂ and electron donors for producing antialgal products. As described herein, the presence of an ammonium ion or a chloroamine further enhances the antialgal activity.

Unless defined otherwise, all technical and scientific terms used herein have the same meaning as commonly understood by one of ordinary skill in the art to which this invention belongs.

The term “haloperoxidase” as used herein refers to any enzyme that oxidizes a halide while consuming hydrogen peroxide. As an example, the haloperoxidase may be an enzyme in the group EC 1.11.1.10. Other examples include lactoperoxidase, bromoperoxidase, iodoperoxidase, chloroperoxidase, and myeloperoxidase. The haloperoxidase of the present invention may be obtained from any biological source or may be synthesized. Haloperoxidases are readily obtained from commercial sources, such as Novozymes, Biodesign, International, Sigma, and DMV International. More than one haloperoxidase may be used.

The hydrogen peroxide (which may be considered the peroxide source) used in the present invention may be derived in many different ways: It may be a concentrated or a diluted hydrogen peroxide solution, or it may be obtained from a hydrogen peroxide precursor, such as percarbonate, perborate, carbamide peroxide (also called urea hydrogen peroxide), or persulfate. It may be obtained from an enzymatic hydrogen peroxide generating system, such as glucose oxidase coupled with glucose or amylase/starch (which generates glucose) plus glucose oxidase. Other enzyme/substrate combinations that generate hydrogen peroxide may be used. It is advantageous to use enzymatic-generated hydrogen peroxide, since all materials involved are environmentally green. It is much easier to transport and handle these materials than hydrogen peroxide itself. More than one peroxide source may be used.

The halide may be obtained from any halide source or generating source and can be from many different sources. It can be ammonium bromide, sodium bromide, potassium bromide, calcium bromide, magnesium bromide, ammonium chloride, sodium chloride, potassium chloride, calcium chloride, magnesium chloride, sodium iodide, potassium iodide, ammonium iodide, calcium iodide, and/or magnesium iodide. It can be any halide salts of alkaline metals or alkaline earth metals. The halide may also be obtained from a quaternary ammonium salt, as described below. For example, quaternary ammonium compounds commonly added to aqueous systems, like swimming pools, can be used as the halide source. Since the quaternary ammonium compounds continue providing control of algae by themselves, the invention provides a method that allows pool sanitation to remain at a high level of effectiveness while the level of chlorine is reduced or maintained to a non-toxic level. In swimming pools with chlorine generator devices, both the sodium chloride used for the generators and the chloramines can be used as the halide source needed for the reaction with the haloperoxidase.

Any other organic compound prepared in a halide containing buffer may supply the halide. For example, the halide may be lysozyme chloride.

The ammonium that may be used in the haloperoxidase antialgal system to provide additional synergistic antialgal effects according to the present invention may be obtained from any ammonium source. The ammonium source can be an ammonium salt. As a non-limiting example, both the halide and the ammonium may be provided by an ammonium halide, such as ammonium bromide (NH₄Br). As a further non-limiting example, both the halide and the ammonium may be provided by a quaternary ammonium compound, which may be a compound with a single quaternary ammonium group or may be a polyquaternary ammonium compound. Examples of suitable quaternary ammonium compounds include for example, benzalkonium choride, (oxydiethyleneglycol)bis(coco alkyl)dimethyl ammonium chloride, which is commercially available in a formulation under the Trademark BUSAN 1014 from Buckman Laboratories International, Inc., N,N-dichlorobenzenesulfonamide(dichloramine B), N,N-diethyl-N-dodecyl-N-benzylammonium chloride, N,N-dimethyl-N-octadecyl-N-(dimethylbenzyl)ammonium chloride, N,N-dimethyl-N,N-didecylammonium chloride, N,N-dimethyl-N,N-didodecylammonium chloride, N,N,N-trimethyl-N-tetradecylammonium chloride, N-benzyl-N,N-dimethyl-N-(C₁₂-C₁₈ alkyl)ammonium chloride, N-(dichlorobenzyl)-N,-N-dimethyl-N-dodecylammonium chloride, N-hexadecylpyridinium chloride, N-hexadecylpyridinium bromide, N-hexadecyl-N,N,N-trimethylammonium bromide, N-dodecylpyridinium chloride, N-dodecylpyridinium bisulphate, N-benzyl-N-dodecyl-N,N-bis(beta-hydroxy-ethyl)ammonium chloride, N-dodecyl-N-benzyl-N,N-dimethylammonium chloride, N-benzyl-N,N-diethyl-N-(C₁₂-C₁₈alkyl) ammonium chloride, ethyl-n-hexadecyl dimethylammonium bromide, N-dodecyl-N,N-dimethyl-N-ethylammonium ethylsulfate, N-dodecyl-N,N-dimethyl-N-(1-naphthylmethyl) ammonium chloride, N-hexadecyl-N,N-dimethyl-N-benzylammonium chloride or N-dodecyl-N,N-dimethyl-N-benzylammonium chloride. The quaternary ammonium compound may also be a polyquaternary ammonium compound. Antimicrobial polyquaternary ammonium compounds which may be used include those described in U.S. Pat. Nos. 3,874,870, 3,931,319, 4,027,020, 4,089,977, 4,111,679, 4,506,081, 4,581,058, 4,778,813, 4,970,211, 5,051,124, 5,093,078, 5,142,002 and 5,128,100 which are incorporated herein by reference thereto. Examples of a polyquaternary ammonium compound are poly(oxyethylene-(dimethyliminio)ethylene(dimethyliminio)ethylenedichloride), which is commercially available under the Trademark WSCP from Buckman Laboratories International, Inc., and bis (2-chloroethyl) ether-N,N,N′,N′-tetramethylethylenediamine copolymer), which is commercially available under the Trademark BUSAN 77 from Buckman Laboratories International, Inc.

As an alternative, algae may be controlled in chlorinated water systems by providing a haloperoxidase and hydrogen peroxide or a peroxide source to the water system under conditions wherein the haloperoxidase and/or peroxide interact with halides and ammonium that are already present in the water system to form a strong antialgal composition. The interaction can be a chemical reaction or a synergistic mode of action. For example, a chlorinated water system may include any body or vessel of water that has been treated with chlorine, sodium chloride, and/or chloramines and that contains residual chlorine ions and/or chloramines. The chloride ions or chloramines may be present in the aqueous system for example at a concentration in the range of from about 0.1 to about 10000 ppm, and typically in the range of from about 1 to about 500 ppm. In particular, the amount of chloride ions or chloramines may be less than the amount that would be present in a system in which chlorine alone was used to control algae. It is not necessary that the water system be subject to a current regimen of chlorination, as long as it was treated with chlorine, sodium chloride, and/or chloramines sometime in the past and still contains residual chlorine ions and/or chloramines with at least the concentration described herein. The term “chlorinated water system” applies not only to heavily chlorinated water systems such as swimming pools and hot tubs but also to any form of water that has been treated with chlorine and/or chloramines as a disinfectant, such as, for example, tap water obtained from municipal sources. A water system may also contain chloramines, which refers to monochloramine (NH₂Cl), dichloramine (NHCl₂), trichloroamine (NCl₃) and/or to any substituted chloramine. Chloramines may be present in a chlorinated water system, either as an additive or byproduct of a disinfection process or as a result of a reaction of chlorine with ammonia, ammonium ions, ammonium compounds, and/or amine compounds that are present in the water from environmental sources. For example, an open body of water may contain ammonia, ammonium ions, ammonium compounds, and/or amine compounds from runoff that enters the body of water containing herbicides, pesticides, and/or fertilizers, animal wastes and/or other environmental sources of ammonia, ammonium ions, ammonium compounds, and/or amine compounds. The chlorinated water system may also include ammonium ions or quaternary ammonium compounds from these same types of sources.

One of ordinary skill can readily determine the effective amount of the various compositions of the present invention useful for a particular application by simply testing various concentrations prior to treatment of an entire affected substrate or system. For instance, in an aqueous system to be treated, the concentration of haloperoxidase may be any effective amount, such as in a range of from about 0.01 to about 1000 ppm, and is preferably in a range of from about 0.1 to about 50 ppm or from about 5 ppm to about 50 ppm. Amounts above these ranges can be used.

The peroxide source may be present in the aqueous system in any effective amount, such as in a sufficient amount to provide a concentration of hydrogen peroxide in the system in a range of from about 0.01 to about 1000 ppm, and preferably in the range of from about 0.1 to about 200 ppm or from about 10 ppm to about 200 ppm. Amounts above these ranges can be used.

The halide may be present in the aqueous system in any effective amount, such as at a concentration in the aqueous system in a range of from about 0.1 to about 10000 ppm, and preferably in the range of from about 1 to about 500 ppm. Amounts above these ranges can be used.

The ammonium source may be present in the aqueous system in any effective amount, such as in a sufficient concentration to provide an ammonium ion concentration in the aqueous system in a range of from 0.0 to about 10000 ppm or in a range of from about 0.1 to about 10000 ppm, and preferably in the range of from about 0 to about 500 ppm or in a range of from about 1 to about 500 ppm. Amounts above these ranges can be used. 10043] As discussed above, a chlorinated water system can typically contain chloride ions or chloramines in a range of from about 0.1 to about 10000 ppm, and typically in the range of from about 100 to about 500 ppm and may contain ammonium ions in a range of from 0 to about 10000 ppm and typically in the range of from about 10 to about 500 ppm. Therefore, it may not be necessary to add additional halide and ammonium source to a chlorinated water system. However, amounts above these ranges can be used.

The concentrations of the components of a haloperoxidase antialgal system, as described above or as described elsewhere in this application, may be the initial concentrations of the components at the time that the components are added to an aqueous system and/or may be the concentrations of the components at any time after the components have interacted with each other.

The present invention also embodies the separate addition of the components to an aqueous system. According to this embodiment, the components are individually added to the products, materials, or media so that the final amount of each component present at the time of use is that amount effective to control the growth of algae. According to an aspect of the present invention, the haloperoxidase, hydrogen peroxide or a peroxide source, halide, and optional ammonium source may be added separately to an aqueous system to be treated. For example, a halide and, optionally, an ammonium source may be added first to the aqueous system to be treated, then the haloperoxidase may be added, finally the hydrogen peroxide may be added. The order of component addition is not critical and any order can be used. Preferably, the order of addition is 1) halide/ammonium, 2) haloperoxidase, and 3) hydrogen peroxide or other peroxide source. Moreover, the haloperoxidase and peroxide source may be pre-mixed and then added to the aqueous system. Thus, the ingredients can be added as a batch, sequentially, continuously, semi-continuously, and the like.

According to another aspect of the present invention, the components of an antialgal system as described herein can be pre-mixed in water to form a concentrated aqueous solution. The concentrated aqueous solution may then be applied to an aqueous system or substrate to be treated. The concentration of the haloperoxidase, hydrogen peroxide or a peroxide source, halide, and optional ammonium source may be selected to optimize the antialgal activity.

The concentration of haloperoxidase in the pre-mixed solution may be in the range of from about 0.01 wt % to about 5 wt %, with a preferred range of from about 0.05 wt % to about 0.5 wt %. All wt % herein are by weight of the solution pre-mixed. The peroxide source may be present in the pre-mixed solution in a sufficient amount to provide a concentration of hydrogen peroxide in the pre-mixed solution in a range of from about 2 ppm to about 15 wt %, with a preferred range of from about 3 ppm to about 1.5 wt %. The halide source may be present in the pre-mixed solution in a sufficient concentration to provide a halide concentration in the pre-mixed solution in a range of from about 3 ppm to about 50 wt %, with a preferred range of from about 5 ppm to about 5 wt %. The ammonium source may be present in the pre-mixed solution in a sufficient concentration to provide an ammonium concentration in the pre-mixed solution in a range of from 0.0 wt % to about 50 wt % or from about 0.1 wt % to about 50 wt %, with a preferred range of from about 0.0 wt % to about 5 wt % or from about 0.5 wt % to about 5 wt %.

The present invention further provides for an all-solid composition in which the components of a haloperoxidase antialgal system can be stored and maintained in a non-reactive state and then combined with water when needed to form an antialgal agent. For example, for an antialgal system comprising haloperoxidase and an enzymatic hydrogen peroxide generating system, such as glucose oxidase coupled with glucose or amylase/starch plus glucose oxidase, a halide and an ammonium source, a solid mixture of haloperoxidase, the substrate for the enzymatic hydrogen peroxide generating system, the halide and the ammonium source can be stored in one container and the enzyme for the enzymatic hydrogen peroxide generating system can be stored separately in another container. If water-soluble containers are used, an antialgal agent can be produced by combining the containers with water to dissolve the components therein to form a concentrated solution, or by adding the containers directly to an aqueous system. Alternatively, the containers can be added separately to an aqueous system to be treated.

As a specific example, a solid mixture of lactoperoxidase, an ammonium halide, and glucose may be provided in one water-soluble bag or container, and a solid glucose oxidase may be provided in another water-soluble bag or container. Dissolving all of the solids in the above two water-soluble bags in a desirable amount of water forms a potent antialgal solution. The resulting solution may then be applied in an effective amount to an aqueous system or substrate to be treated. Alternatively, both bags could be added directly to an aqueous system to be treated, or the two bags could be added separately to the aqueous system. As another specific example, instead of two separate containers for storing the solid components, one single container having separate chambers could be used, as long as there is sufficient separation so that the components of the antialgal system are kept in a solid and inactive form before they are exposed to water. For example, one chamber could contain a solid mixture of lactoperoxidase, an ammonium halide, and glucose and the other chamber could contain a solid glucose oxidase. It is preferred to keep all of the ingredients of the antialgal system in a non-reacting form before mixing with water. Preferably, in a storage system wherein glucose oxidase is kept separately in solid form, the glucose oxidase can be kept in an anaerobic condition so that oxygen is physically separated from the glucose oxidase, thereby maintaining the glucose oxidase in a substantially non-reacting form. Depending upon the specific application, the composition can be prepared in liquid form by dissolving the composition in water or in an organic solvent, or in dry form by adsorbing onto a suitable vehicle, or compounding into a tablet form. The preservative containing the composition of the present invention may be prepared in an emulsion form by emulsifying it in water, or if necessary, by adding a surfactant. Additional chemicals, such as insecticides, may be added to the foregoing preparations depending upon the intended use of the preparation.

The method of the present invention may be practiced at any pH, such as a pH range of from about 2 to about 11, with a preferable pH range of from about 5 to about 9. The pH of the pre-mixed solution of the antialgal system may be adjusted by adding an acid(s) or a base(s) as is known in the art. The acid or base added should be selected to not react with any components in the system. However, it is preferable to mix the components in water without pH adjustment. For aqueous systems that are intended to be conducive to contact with humans or other higher organisms, a neutral pH is preferred.

The method of the present invention may be used in any industrial or recreational aqueous systems requiring microorganism control. Such aqueous systems include, but are not limited to, metal working fluids, cooling water systems (cooling towers, intake cooling waters and effluent cooling waters), waste water systems including waste waters or sanitation waters undergoing treatment of the waste in the water, e.g. sewage treatment, recirculating water systems, swimming pools, ponds, lakes, hot tubs, spa, public bath, food processing systems, drinking water systems, leather-processing water systems, white water systems, pulp slurries and other paper-making or paper-processing water systems. In general, any industrial or recreational water system can benefit from the present invention. The method of the present invention may also be used in the treatment of intake water for such various industrial processes or recreational facilities. Intake water can be first treated by the method of the present invention so that the algae growth is inhibited before the intake water enters the industrial process or recreational facility.

The present invention will be further clarified by the following examples, which are intended to be exemplary of the present invention.

### EXAMPLES

Evaluation of Algaecidal Activity: This test method provides a technique for screening newly synthesized compounds for their effectiveness to inhibit (repress) algae growth. MIC values represents the Minimum Inhibitory Concentration, defined as the lowest level of compound required to completely inhibit (repress) the growth of a given organism.

Apparatus: Test tubes, 18-150 mm. Sterilized test tubes are required.

Incubator, capable of a constant (±2° C.) temperature and light regulation.

Reagents and Materials:

KNO₃
K₂HPO₄
MgSO₄•7H₂O
Fe-ammonium citrate (1% solution)

Stock solutions

| Stock solution component | g/200 g deionized water | |
|---|---|---|
| A. K₂HPO₄ | 1.50 | |
| B. MgSO₄•7H₂O | 1.50 | |
| C. Na₂CO₃ | 0.80 | |
| D. CaCl₂•2H₂O | 0.50 | |
| E. Na₂SiO₃•9H₂O | 1.16 | |
| F. Citric acid | 1.20 | |
| G. PIV metals | | |
| Na₂ EDTA | 0.750 | g |
| FeCl₃•6H₂O | 0.097 | g |
| MnCl₂•4H₂O | 0.041 | g |
| ZnCl₂ | 0.005 | g |
| CoCl₂•6H₂O | 0.002 | g |
| Na₂MoO₄•2H₂O | 0.004 | g |
| Deionized water | 1,000.000 | ml |

Inoculum: Cell suspension from a culture grown in modified Allen's medium for 14 days or as needed to attain a desired cell mass of Chlorella sp. (ATCC 7516) or Phormidium faveolarum (UTEX 427). The inoculum is calibrated at 82% transmittance measured at 590 nanometers wavelength before inoculation.

Procedure: Medium preparation: Modified Allen's medium (Allen, A. A., 1968).

| | | |
|---|---|---|
| NaNO₃ | 1.5 | g |
| K₂HPO₄ | 5.0 | ml stock solution A. |
| MgSO₄•7H₂O | 5.0 | ml stock solution B. |
| Na₂CO₃ | 5.0 | ml stock solution C. |
| CaCl₂•2H₂O | 10.0 | ml stock solution D. |
| Na₂SiO₃•9H₂O | 10.0 | ml stock solution E. |
| Citric acid | 1.0 | ml stock solution F. |
| PIV metal | 1.0 | ml stock solution G. |
| Deionized water | 1000.0 | ml. |

Sterilize the medium in the autoclave for 20 minutes at 15 pounds pressure (121° C.). After autoclaving, cool medium to 45-50° C. and dispense 5 ml of medium per test tube, then add the compound and the inoculum.

Compound incorporation: Prepare a stock solution in water of the compound to be tested. The concentration of the stock solution is dependent on the largest dosage desired to be tested. Dilute the stock solution to obtain dosages smaller than that chosen for the stock solution. A maximum amount of 100 microliters of stock solution or the corresponding dilution should be added per test tube.

Inoculation: Add 100 microliters of inoculum per test tube, per type of medium and type of inoculum.

Incubation: Place the test tubes containing the treatments in an incubator set at 24° C. Light is provided by plant growth fluorescent tubes set to provide 16 h of light and 8 h of darkness.

Rating of the tubes: The test tubes with the treatments are rated positive or negative:
Positive (contaminated) when the medium in the tubes shows algae growth (green deposit at the bottom).
Negative (not contaminated) when the medium in the tubes remains colorless.

The control is always positive. The minimum inhibitory concentration (MIC) of the compound is the smallest dosage showing negative algae growth.

Synergy Evaluation: Synergy was measured by checkerboards dilutions (Yan and Hancock, 2001), in which one compound is diluted along the rows of test tubes and the other is diluted along the columns. This method focuses on looking for a reduction in the MIC of each component in the presence of the other. The result is expressed as the Fractional Inhibitory Concentration Index (FIC), calculated as follows:
FIC=[A]/MIC_{A}+[B]/MIC_{B} where,
MIC_{A} and MIC_{B}=MICs of the compounds A and B alone
[A] and [B]=MICs of the compounds A and B when in combination.

An FIC index <1 indicates synergy; an index of 0.5 represents the equivalent of a fourfold decrease in the MIC of each compound in combination. An FIC index of 1.0 represents additive activity (a twofold decrease in the MIC of each compound in combination), and an index >1 indicates antagonism; an index >4 represents true antagonism.

Evaluation of Bactericidal Activity: This method is suitable for use in evaluating the antibacterial properties of chemicals by determining their MIC value. The MIC value represents the Minimum Inhibitory Concentration defined as the lowest level of compound required to achieve a ≧90% kill of a given organism.

Equipment
1. Test tubes, 18×150 mm disposable culture tubes sterile
2. Sterile 1 ml and 10 ml pipettes
3. Incubator capable of maintaining a temperature of 37° C.±1° C.
4. Autoclave
5. pH meter
6. 1-200 μl micropipette tips
7. Eppendorf micropipette
8. McFarland Standard #1
9. Petri Dishes: Plastic disposable Petri-dishes, 100×15 mm size

Media Preparation: Difco Plate Count Agar: Rehydrate the agar by suspending 23.5 g in 1-L of deionized water and heat to boiling to dissolve. Dispense as desired and sterilize in a steam autoclave for 15 minutes at 121° C.

Basal Salts Substrate, pH 7:

| | | |
|---|---|---|
| Trizma ® (Tris) HCl | 3.9 | g |
| Trizma ® (Tris) Base. | 0.05 | g |

(Note: Obtain proper pH before addition of the following. Adjust with
either more of the appropriate Trizma ® buffer)

| | | |
|---|---|---|
| Glucose | 0.02 | grams |
| Peptone | 0.01 | grams |
| Ammonium nitrate | 1.0 | grams |
| Magnesium sulfate, heptahydrate | 0.25 | grams |
| Calcium Chloride | 0.25 | grams |

Autoclave at 121° C. for 15 minutes

Inoculum: Cell suspension from an 18 to 24 hour bacterial culture of Staphylococcus aureus (ATCC 6538) or Bacillus subtilis (ATCC 6633) or Enterobacter aerogenes (ATCC 13048) to attain a desired cell concentration. Using a McFarland nephelometer barium sulfate standard or some other suitable method, adjust the concentration of the bacterial suspension so that a final concentration of between 1×10⁴ and 1×10⁵ cells per ml is achieved when 100 μl of the inoculum is added to 5 ml of basal salts substrate.

Compound Incorporation: Prepare a stock solution in water of the compound to be tested. The concentration of the stock solution is dependent on the largest dosage desired to be tested. Dilute the stock solution to obtain dosages smaller than that chosen for the stock solution. A maximum amount of 100 μl of stock solution or the corresponding dilution should be added per test tube.

Inoculation and incubation: Add 100 μl of inoculum per test tube per type of medium and type of inoculum, and incubate at 37° C. for 18 hours.

Rating of tubes via plate count method: The Pour Plate Count agar was prepared as described in Standard Methods (American Public Health Association; 1995). One milliliter of the sample was placed on the center of a sterile petri dish (100-mm diameter) by using a sterile pipette. Sterile, molten (44 to 46° C.) plate count agar (pH 7.0; Difco) was added and mixed with the sample by swirling the plate. The samples were allowed to cool at room temperature until solidified and then were inverted and incubated at 35±0.5° C. for 48±2 h. Colonies formed in or on the plate count medium within 48±2 h were counted as described in Standard Methods, and the results were reported as CFU/milliliter. Where applicable, this value was multiplied by the dilution factor to obtain the corrected CFU/milliliter.

In this test, the MIC of the compound is the concentration that produced 90% kill. This is calculated using the following equation:

### Average CFU/ml in Controls—Average CFU/ml in Treatment×100 Average CFU/ml in Controls

### Example 1

### The Use of a Haloperoxidase, a Hydrogen Peroxide Source, a Halide Source to Control Algae

The potential to control Chlorella sp. (ATCC 7516) with a lactoperoxidase (DMV International), a haloperoxidase (Novozyme), a myeloperoxidase (Biodesign International) or a bromoperoxidase (Sigma) was evaluated using 2 ppm a.i. of hydrogen peroxide as a substrate and 4 ppm a.i. of ammonium bromide as an electron donor.

| Lactoperoxidase | Haloperoxidase | Myeloperoxidase | Bromoperoxidase |
|---|---|---|---|
| MIC (ppm | MIC (ppm | MIC (ppm | MIC (ppm |
| product) | product) | product) | product) |
| >0.5 < 1 | <0.1 | <0.1 | <0.1 |

The potential to control Pseudomonas aeruginosa with a haloperoxidase (Novozyme) was evaluated using 2 ppm a.i. of hydrogen peroxide as a substrate and 25 ppm of ammonium bromide as an electron donor.

Haloperoxidase
MIC (ppm product)
0.5

The potential to control Chlorella sp. (ATCC 7516) with a haloperoxidase (Novozyme) and a myeloperoxidase (Biodesign International) was evaluated using 2 ppm a.i. of hydrogen peroxide as a substrate and 4 ppm a.i. of ammonium chloride as an electron donor.

| Haloperoxidase | Myeloperoxidase |
|---|---|
| MIC (ppm product) | MIC (ppm product) |
| >1 < 5 | >0.5 < 1 |

Note:
the lactoperoxidase and the bromoperoxidase were not included because they can not use a chloride as an electron donor.

### Example 2

### The Use of Benzalkonium Chloride as a Halide/Ammonium Source in a Haloperoxidase System Against Chlorella sp.

Benzalkonium Chloride (Sigma) was evaluated as halide source in a system using a Haloperoxidase (Novozyme) and 1 ppm a.i. Hydrogen Peroxide as a substrate. The alga tested was Chlorella sp. (ATCC 7516). The incubation period was 14 days at 24° C. under 16 h of light and 8 h of darkness.

| Benzalkonium | | | | |
|---|---|---|---|---|
| Chloride | Haloperoxidase | | | [A]/MIC_{A} + |
| [A] | [B] | [A]/MIC_{A} | [B]/MIC_{B} | [B]/MIC_{B} |
| 0 | 10 MIC_{B} | 0.0 | 1.00 | 1.00 |
| 0.1 | 10 | 0.1 | 1.00 | 1.10 |
| 0.5 | 0.1 | 0.5 | 0.01 | 0.51* |
| 1 MIC_{A} | 0 | 1.0 | 0.00 | 1.00 |

MIC_{A} = MIC of Benzalkonium Chloride = 1.00 mg a.i./l
MIC_{B} = MIC of Haloperoxidase alone = 10 mg product/l
[A] = MIC of Benzalkonium Chloride in combination with Haloperoxidase (mg a.i./l)
[B] = MIC of Haloperoxidase in combination with Benzalkonium Chloride (mg product/l)
*= A value <1 denotes synergistic activity of both components used simultaneously.

The presence of synergism between the compounds indicated enzymatic activity.

### Example 3

### The Use of Benzalkonium Chloride as a Halide/Ammonium Source in a Haloperoxidase System Against Phomidium faveolarum

Benzalkonium Chloride (Sigma) was evaluated as halide source in a system using a Haloperoxidase (Novozyme) and 1 ppm a.i. Hydrogen Peroxide as a substrate. The alga tested was Phomidium faveolarum (UTEX 427). The incubation period was 14 days at 24° C. under 16 h of light and 8 h of darkness.

| Benzalkonium | | | | |
|---|---|---|---|---|
| Chloride | Haloperoxidase | | | [A]/MIC_{A} + |
| [A] | [B] | [A]/MIC_{A} | [B]/MIC_{B} | [B]/MIC_{B} |
| 0 | 10 MIC_{B} | 0.00 | 1.00 | 1.00 |
| 0.1 | 10 | 0.05 | 1.00 | 1.05 |
| 0.5 | 10 | 0.25 | 1.00 | 1.25 |
| 1 | 0.1 | 0.50 | 0.01 | 0.60* |
| 2 MIC_{A} | 0.0 | 1.00 | 0.00 | 1.00 |

MIC_{A} = MIC of Benzalkonium Chloride = 2.00 mg a.i./l
MIC_{B} = MIC of Haloperoxidase alone = 10 mg product/l
[A] = MIC of Benzalkonium Chloride in combination with Haloperoxidase (mg a.i./l)
[B] = MIC of Haloperoxidase in combination with Benzalkonium Chloride (mg product/l)
*= A value <1 denotes synergistic activity of both components used simultaneously.

The presence of synergism between the compounds indicated enzymatic activity.

### Example 4

### The Use of Busan 1014 as a Halide/Ammonium Source in a Haloperoxidase System Against Pseudomonas aeruginosa

Busam 1014 (Buckman Laboratories, Int.) was evaluated as halide source in a system using a Haloperoxidase (Novozyme) and 2 ppm a.i. Hydrogen Peroxide as a substrate. The bacteria tested were Pseudomonas aeruginosa. The incubation period was 18 hours at 37° C.

| Busan 1014 | Haloperoxidase | | | [A]/MIC_{A} + |
|---|---|---|---|---|
| [A] | [B] | [A]/MIC_{A} | [B]/MIC_{B} | [B]/MIC_{B} |
| 0 | >10 MIC_{B} | 0.00 | 1.00 | 1.00 |
| 1 | 5 | 0.2 | 0.5 | 0.7* |
| 5 | 1 | 1.00 | 0.1 | 1.01 |
| 5 | 0.5 | 1.00 | 0.05 | 1.05 |
| 5 | 0.1 | 1.00 | 0.01 | 1.01 |
| 5 MIC_{A} | 0.0 | 1.00 | 0.00 | 1.00 |

MIC_{A} = MIC of Busan 1014 = 5.00 mg a.i./l
MIC_{B} = MIC of Haloperoxidase alone = >10 mg product/l
[A] = MIC of Busan 1014 in combination with Haloperoxidase (mg a.i./l)
[A] = MIC of Haloperoxidase in combination with Busan 1014 (mg product/l)
*= A value <1 denotes synergistic activity of both components used simultaneously.

The presence of synergism between the compounds indicated enzymatic activity.

### Example 5

### The Use of Ethyl-n-Hexadecyl Dimethylammonium Bromide as a Halide/Ammonium Source in a Haloperoxidase System Against Chlorella sp.

Ethyl-n-Hexadecyl Dimethylammonium Bromide (EHDB) (AlfaAesar) was evaluated as halide source in a system using a Haloperoxidase (Novozyme) and 1 ppm a.i. Hydrogen Peroxide as a substrate. The alga tested was Chlorella sp. (ATCC 7516). The incubation period was 14 days at 24° C. under 16 h of light and 8 h of darkness.

| EHDB | Haloperoxidase | | | [A]/MIC_{A} + |
|---|---|---|---|---|
| [A] | [B] | [A]/MIC_{A} | [B]/MIC_{B} | [B]/MIC_{B} |
| 0 | 10 MIC_{B} | 0.0 | 1.00 | 1.00 |
| 0.1 | 1.0 | 0.2 | 0.10 | 0.30* |
| 0.3 | 0.5 | 0.6 | 0.05 | 0.65 |
| 0.5 MIC_{A} | 0 | 1.0 | 0.00 | 1.00 |

MIC_{A} = MIC of EHDB = 0.5 mg a.i./l
MIC_{B} = MIC of Haloperoxidase alone = 10 mg product/l
[A] = MIC of EHDB in combination with Haloperoxidase (mg a.i./l)
[B] = MIC of Haloperoxidase in combination with EHDB (mg product/l)
*= A value <1 denotes synergistic activity of both components used simultaneously.

The presence of synergism between the compounds indicated enzymatic activity.

### Example 6

### The Use of Ethyl-n-Hexadecyl Dimethylammonium Bromide as a Halide/Ammonium Source in a Haloperoxidase System Against Phomidium faveolarum

Ethyl-n-Hexadecyl Dimethylammonium Bromide (EHDB) (AlfaAesar) was evaluated as halide source in a system using a Haloperoxidase (Novozyme) and 1 ppm a.i. Hydrogen Peroxide as a substrate. The alga tested was Phomidium faveolarum (UTEX 427). The incubation period was 14 days at 24° C. under 16 h of light and 8 h of darkness.

| EHDB | Haloperoxidase | | | [A]/MIC_{A} + |
|---|---|---|---|---|
| [A] | [B] | [A]/MIC_{A} | [B]/MIC_{B} | [B]/MIC_{B} |
| 0 | 10 MIC_{B} | 0.0 | 1.00 | 1.00 |
| 0.1 | 1.0 | 0.2 | 0.10 | 0.30* |
| 0.3 | 0.1 | 0.6 | 0.01 | 0.61 |
| 0.5 MIC_{A} | 0 | 1.0 | 0.00 | 1.00 |

MIC_{A} = MIC of EHDB = 0.5 mg a.i./l
MIC_{B} = MIC of Haloperoxidase alone = 10 mg product/l
[A] = MIC of EHDB in combination with Haloperoxidase (mg a.i./l)
[B] = MIC of Haloperoxidase in combination with EHDB (mg product/l)
*= A value <1 denotes synergistic activity of both components used simultaneously.

The presence of synergism between the compounds indicated enzymatic activity.

### Example 7

### Activity of Benzalkonium Chloride and Haloperoxidase Upon reinoculation

Two tests using Benzalkonium Chloride (Sigma) as halide source in a system using a Haloperoxidase (Novozyme) and 1 ppm a.i. Hydrogen Peroxide as a substrate were set. After 14 days of incubation, one test was reinoculated with Chlorella sp. (ATCC 7516) to evaluate if Benzalkonium Chloride was still active and the other test was reinoculated with Chlorella sp. (ATCC 7516) and treated with 1 ppm of hydrogen peroxide to determine if the enzyme was still active. Both tests were incubated 14 days at 240 C under 16 h of light and 8 h of darkness.

Reinoculated Only

The result of this test (not shown) indicated that Benzalkonium Chloride was controlling algae growth at a dosage of 2 ppm a.i.

Reinoculated and treated with 1 ppm of hydrogen peroxide

| Benzalkonium | | | | |
|---|---|---|---|---|
| Chloride | Haloperoxidase | | | [A]/MIC_{A} + |
| [A] | [B] | [A]/MIC_{A} | [B]/MIC_{B} | [B]/MIC_{B} |
| 0 | 10 MIC_{B} | 0.0 | 1.00 | 1.00 |
| 0.1 | 10 | 0.05 | 1.00 | 1.05 |
| 0.5 | 5 | 0.25 | 0.5 | 0.75* |
| 1 | 5 | 0.5 | 0.5 | 1.00 |
| 2 MIC_{A} | 0 | 1.0 | 0.0 | 1.00 |

MIC_{A} = MIC of Benzalkonium Chloride = 2.00 mg a.i./l
MIC_{B} = MIC of Haloperoxidase alone = 10 mg product/l
[A] = MIC of Benzalkonium Chloride in combination with Haloperoxidase (mg a.i./l)
[B] = MIC of Haloperoxidase in combination with Benzalkonium Chloride (mg product./l)
*= A value <1 denotes synergistic activity of both components used simultaneously.

The presence of synergism between the compounds indicated that the enzyme was still active.

### Example 8

### The Use of Dichloramine B as a Halide/Ammonium Source in a Haloperoxidase System Against Chlorella sp.

Dichloramine B (TCI America) was evaluated as halide source in a system using 1 ppm product of Haloperoxidase (Novozyme) and 2 ppm a.i. Hydrogen Peroxide as a substrate. The alga tested was Chlorella sp. (ATCC 7516). The incubation period was 14 days at 24° C. under 16 h of light and 8 h of darkness.
MIC Haloperoxidase alone=>10 ppm product
MIC Hydrogen Peroxide alone=>3<4 ppm a.i.
MIC Dichloramine B alone=>0.1<0.4 ppm a.i.
MIC Dichloramine B combined with 1 ppm product of Haloperoxidase (Novozyme) and 2 ppm a.i. Hydrogen Peroxide=<0.07 ppm a.i.

### Example 9

### The Use of Dichloramine B as a Halide/Ammonium Source in a Haloperoxidase System Against Enterobacter aerogenes

Dichloramine B (TCI America) was evaluated as a halide source in a system using Haloperoxidase (Novozyme) and 2 ppm a.i. Hydrogen Peroxide as a substrate. The bacteria tested were Enterobacter aerogenes (ATCC 13048). The incubation period was 18 hours at 37° C.

| Dichloramine B | Haloperoxidase | | | [A]/MIC_{A} + |
|---|---|---|---|---|
| [A] | [B] | [A]/MIC_{A} | [B]/MIC_{B} | [B]/MIC_{B} |
| 0 | 5 MIC_{B} | 0.0 | 1.00 | 1.00 |
| 0.5 | 1 | 0.1 | 0.2 | 0.3* |
| 1 | 1 | 0.2 | 0.2 | 0.4* |
| 1 | 0.5 | 0.2 | 0.1 | 0.3* |
| 5 MIC_{A} | 0 | 1.0 | 0.0 | 1.00 |

MIC_{A} = MIC of Dichloramine B = 5.00 mg a.i./l
MIC_{B} = MIC of Haloperoxidase alone = 5 mg product/l
[A] = MIC of Dichloramine B in combination with Haloperoxidase (mg a.i./l)
[B] = MIC of Haloperoxidase in combination with Dichloramine B (mg product/l)
*= A value <1 denotes synergistic activity of both components used simultaneously.

The presence of synergism between the compounds indicated enzymatic activity.

### Example 10

### The Use of Lysozyme Chloride as a Halide Source in a Haloperoxidase System Against Chlorella sp.

Lysozyme chloride (MP Biomedicals) was evaluated as halide source in a system using a Haloperoxidase (Novozyme) and 1 ppm a.i. Hydrogen Peroxide as a substrate. The alga tested was Chlorella sp. (ATCC 7516). The incubation period was 14 days at 24° C. under 16 h of light and 8 h of darkness.

After the 14 days of incubation, the test was reinoculated with the same organism and incubated for additional 14 days under the same conditions above mentioned to determine if lysozyme chloride continued providing control of algae by itself.

Results after 14 days of incubation

| Lysozyme | Haloperoxidase | | | [A]/MIC_{A} + |
|---|---|---|---|---|
| [A] | [B] | [A]/MIC_{A} | [B]/MIC_{B} | [B]/MIC_{B} |
| 0 | 10 MIC_{B} | 0.0 | 1.00 | 1.00 |
| 0.1 | 10 | 0.1 | 1.00 | 1.10 |
| 0.5 | 0.1 | 0.5 | 0.01 | 0.51* |
| 1 MIC_{A} | 0 | 1.0 | 0.00 | 1.00 |

MIC_{A} = MIC of Lysozyme Chloride alone = 1.00 mg product/l
MIC_{B} = MIC of Haloperoxidase alone = 10 mg product./l
[A] = MIC of Lysozyme Chloride in combination with Haloperoxidase (mg product/l)
[B] = MIC of Haloperoxidase in combination with Lysozyme Chloride (mg product/l)
*= A value <1 denotes synergistic activity of both components used simultaneously.

The presence of synergism between the compounds indicated enzymatic activity.

Results After Reinoculation

The results after reinoculation (not shown) indicated that Lysozyme Chloride was controlling algae growth at an MIC of 2 ppm product.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of controlling the growth of algae in an aqueous system or on a substrate capable of supporting a growth of algae, the method comprising:
providing a) at least one haloperoxidase, b) at least one peroxide source, c) at least one halide, and optionally, d) at least one ammonium source under conditions wherein the haloperoxidase, peroxide from the peroxide source, halide and, optionally, ammonium from the ammonium source, interact to provide an antialgal agent to said aqueous system or said substrate and wherein said antialgal agent controls the growth of algae in the aqueous system or on the substrate.

2. The method of claim 1, wherein the peroxide source is carbamide peroxide, percarbonate, perborate or persulfate, or combinations thereof.

3. The method of claim 1, wherein the hydrogen peroxide generating enzyme is glucose oxidase and the enzyme substrate is glucose.

4. The method of claim 1, wherein the halide is in the form of a halide salt of an alkaline metal or alkaline earth metal.

5. The method of claim 1, wherein the halide is ammonium bromide, sodium bromide, potassium bromide, calcium bromide, magnesium bromide, sodium iodide, potassium iodide, ammonium iodide, calcium iodide, magnesium iodide, ammonium chloride, sodium chloride, potassium chloride, calcium chloride, magnesium chloride, or combinations thereof.

6. The method of claim 1, wherein the halide and the ammonium source are both provided by an ammonium halide.

7. The method of claim 1, wherein the halide and the ammonium source are both provided by ammonium bromide.

8. The method of claim 1, wherein the halide and ammonium are both provided by a quaternary ammonium halide or a polyquaternary ammonium halide.

9. The method of claim 1, wherein the halide and ammonium are both provided by benzalkonium chloride, (oxydiethyleneglycol)bis(coco alkyl)dimethyl ammonium chloride, N,N-dichlorobenzenesulfonamide, N,N-diethyl-N-dodecyl-N-benzylammonium chloride, N,N-dimethyl-N-octadecyl-N-(dimethylbenzyl)ammonium chloride, N,N-dimethyl-N,N-didecylammonium chloride, N,N-dimethyl-N,N-didodecylammonium chloride, N,N,N-trimethyl-N-tetradecylammonium chloride, N-benzyl-N,N-dimethyl-N-(Clhd 12-C₁₈ alkyl) ammonium chloride, N-(dichlorobenzyl)-N,-N-dimethyl-N-dodecylammonium chloride, N-hexadecylpyridinium chloride, N-hexadecylpyridinium bromide, N-hexadecyl-N,N,N-trimethylammonium bromide, N-dodecylpyridinium chloride, N-dodecylpyridinium bisulphate, N-benzyl-N-dodecyl-N,N-bis(beta-hydroxy-ethyl)ammonium chloride, N-dodecyl-N-benzyl-N,N-dimethylammonium chloride, N-benzyl-N,N-dimethyl-N-(C₁₂-C₁₈ alkyl)ammonium chloride, ethyl-n-hexadecyl dimethylammonium bromide, N-dodecyl-N,N-dimethyl-N-ethylammonium ethyl sulfate, N-dodecyl-N,N-dimethyl-N-(1-naphthylmethyl)ammonium chloride, N-hexadecyl-N,N-dimethyl-N-benzylammonium chloride or N-dodecyl-N,N-dimethyl-N-benzylammonium chloride.

10. The method of claim 1, wherein the halide and ammonium are both provided by poly(oxyethylene-(dimethyliminio)ethylene(dimethyliminio)ethylenedichloride), or bis (2-chloroethyl)ether-N,N,N′,N′-tetramethylethylenediamine copolymer).

11. The method of claim 1, wherein the halide is lysozyme chloride or any enzyme in a halide buffer solution.

12. The method of claim 1, wherein the antialgal agent is provided to an aqueous system by adding the haloperoxidase, peroxide source, halide, and ammonium source to the aqueous system so that the haloperoxidase has a concentration in the aqueous system in the range of from about 0.01 to about 1000 ppm, the peroxide source provides a concentration of hydrogen peroxide in the aqueous system in the range of from about 0.01 to about 1000 ppm, the halide has a concentration in the aqueous system in the range of from about 0.1 to about 10,000 ppm, and the ammonium source provides an ammonium ion at a concentration in the aqueous system in the range of from about 0.0 to about 10,000 ppm.

13. The method of claim 12, wherein the haloperoxidase has a concentration in the aqueous system in the range of from about 0.1 to about 50 ppm, the peroxide source provides a concentration of hydrogen peroxide in the aqueous system in the range of from about 0.1 to about 200 ppm, the halide has a concentration in the aqueous system in the range of from about 1 to about 500 ppm, and the ammonium source provides an ammonium ion at a concentration in the aqueous system in the range of from about 0 to about 500 ppm.

14. The method of claim 1, wherein the peroxide source is an enzymatic hydrogen peroxide generating system comprising glucose oxidase and glucose, wherein the halide and ammonium source are both provided by an ammonium halide, and wherein the antialgal agent is provided to an aqueous system by adding haloperoxidase, an ammonium halide, glucose oxidase and glucose to the aqueous system so that the haloperoxidase has a concentration in the aqueous system in the range of from about 0.01 to about 1000 ppm, the ammonium halide has a concentration in the aqueous system in the range of from about 0.1 to about 10000 ppm, the glucose oxidase has a concentration in the aqueous system in the range of from about 0.01 to about 500 and glucose has a concentration in the aqueous system in the range of from about 1 to about 10,000 ppm.

15. The method of claim 14, wherein the haloperoxidase has a concentration in the aqueous system in the range of from about 0.1 to about 50 ppm, the ammonium halide has a concentration in the aqueous system in the range of from about 1 to about 500 ppm, the glucose oxidase has a concentration in the aqueous system in the range of from about 0.05 ppm to about 50 ppm and glucose has a concentration in the aqueous system in the range of from about 10 ppm to about 5000 ppm.

16. The method of claim 1, wherein the antialgal agent is provided to the aqueous system or substrate by combining the haloperoxidase, peroxide source, halide, and, optionally, an ammonium source with water to form a concentrated solution in which the haloperoxidase, peroxide from the peroxide source, the halide and, optionally, ammonium from the ammonium source interact to provide an antialgal agent in the concentrated solution and then applying the concentrated solution to the aqueous system or the substrate.

17. The method of claim 1, wherein the antialgal agent is provided to the aqueous system or substrate by adding the haloperoxidase, peroxide source, halide, and, optionally, the ammonium source, separately to the aqueous system or the substrate under conditions wherein the antialgal agent is formed in situ in the aqueous system or on the substrate.

18. The method of claim 1, wherein the aqueous system is a metal working system, a cooling water system, a waste water system, a food processing system, a drinking water system, a leather-processing water system, a white water system, a paper-making system or paper-processing system.

19. The method of claim 1, wherein the controlling growth of algae in an aqueous system is carried out by providing the antialgal agent to intake water of a metal working system, a cooling water system, a waste water system, a food processing system, a drinking water system, a leather-processing water system, a white water system for paper-making process, a paper-making system or a paper-processing system.

20. A method of killing or inhibiting the growth of algae in an aqueous system or on a substrate capable of supporting a growth of algae, the method comprising:
providing a first water soluble container containing, in solid form, a haloperoxidase, a halide optionally an ammonium source, and an enzyme substrate of an enzyme that has the property of acting upon the enzyme substrate to produce hydrogen peroxide,
providing a second water soluble container containing, in solid form, an enzyme that has the property of acting upon the enzyme substrate to produce hydrogen peroxide,
adding the first water soluble container and the second water soluble container to water under conditions wherein the enzyme that has the property of acting upon the enzyme substrate to produce hydrogen peroxide acts upon the enzyme substrate to produce hydrogen peroxide and wherein the haloperoxidase, hydrogen peroxide, halide and, optionally, ammonium from the ammonium source, interact to form an antialgal agent, and
providing the antialgal agent to an aqueous system or a substrate and wherein the antialgal agent inhibits the growth of algae in the aqueous system or on the substrate.

21. A method of controlling the growth of algae in a chlorinated water system, the method comprising:
adding at least one haloperoxidase and at least one peroxide source to the chlorinated water system so that the haloperoxidase and peroxide from said peroxide source interact with chloride ions or chloroamines in the chlorinated water system to provide an antialgal agent to said chlorinated water system and wherein said antialgal agent controls the growth of algae in the chlorinated water system.

22. The method of claim 21, wherein the peroxide source is hydrogen peroxide.

23. The method of claim 21, wherein the peroxide source is carbamide peroxide, percarbonate, perborate, persulfate, or combinations thereof.

24. The method of claim 21, wherein the peroxide source is an enzymatic hydrogen peroxide generating system that comprises a hydrogen peroxide generating enzyme and an enzyme substrate that is acted upon by the enzyme to produce hydrogen peroxide.

25. The method of claim 24, wherein the hydrogen peroxide generating enzyme is glucose oxidase and the enzyme substrate is glucose.

26. The method of claim 21, wherein the chlorinated water system comprises a saline solution containing a chlorine generator.

27. The method of claim 21, wherein the chlorinated water system contains sodium chloride in the amount of from 0.1 to about 10000 ppm.

28. The method of claim 21, wherein the haloperoxidase and peroxide source are added to the chlorinated water system so that the haloperoxidase has a concentration in the chlorinated water system in the range of from about 0.01 to about 1000 ppm, the peroxide source provides a concentration of hydrogen peroxide in the chlorinated system in the range of from about 0.01 to about 1000 ppm.

29. The method of claim 21, wherein the chlorinated water system has a chloride ion or chloramine concentration of from about 0.1 to about 10000 ppm.

30. The method of claim 21, wherein the chlorinated water system is a swimming pool, public bath, spa or hot tub.

31. A composition comprising haloperoxidase, a peroxide source, and a quaternary or polyquatemary ammonium halide.

32. The composition of claim 31, wherein the peroxide source is hydrogen peroxide.

33. The composition of claim 31, wherein the peroxide source is carbamide peroxide, percarbonate, perborate or persulfate, or combinations thereof.

34. The composition of claim 31, wherein the peroxide source is an enzymatic hydrogen peroxide generating system that comprises a hydrogen peroxide generating enzyme and an enzyme substrate that is acted upon by the enzyme to produce hydrogen peroxide.

35. The composition of claim 31, wherein the hydrogen peroxide generating enzyme is glucose oxidase and the enzyme substrate is glucose.

36. The composition of claim 31, wherein the composition contains a quaternary ammonium halide that is benzalkonium chloride, (oxydiethyleneglycol)bis(coco alkyl)dimethyl ammonium chloride, N,N-dichlorobenzenesulfonamide, N,N-diethyl-N-dodecyl-N-benzylammonium chloride, N,N-dimethyl-N-octadecyl-N-(dimethylbenzyl)ammonium chloride, N,N-dimethyl-N,N-didecylammonium chloride, N,N-dimethyl-N,N-didodecylammonium chloride, N,N,N-trimethyl-N-tetradecylammonium chloride, N-benzyl-N,N-dimethyl-N-(C₁₂-C18 alkyl)ammonium chloride, N-(dichlorobenzyl)-N,-N-dimethyl-N-dodecylammonium chloride, N-hexadecylpyridinium chloride, N-hexadecylpyridinium bromide, N-hexadecyl-N,N,N-trimethylammonium bromide, N-dodecylpyridinium chloride, N-dodecylpyridinium bisulphate, N-benzyl-N-dodecyl-N,N-bis(beta-hydroxy-ethyl)ammonium chloride, N-dodecyl-N-benzyl-N,N-dimethylammonium chloride, N-benzyl-N,N-dimethyl-N-(C₁₂-C₁₈ alkyl)ammonium chloride, ethyl-n-hexadecyl dimethylammonium bromide, N-dodecyl-N,N-dimethyl-N-ethylammonium ethylsulfate, N-dodecyl-N,N-dimethyl-N-(1-naphthylmethyl)ammonium chloride, N-hexadecyl-N,N-dimethyl-N-benzylammonium chloride or N-dodecyl-N,N-dimethyl-N-benzylammonium chloride.

37. The composition of claim 31, wherein the composition contains a polyquatemary ammonium halide that is poly(oxyethylene-(dimethyliminio)ethylene(dimethyliminio) ethylenedichloride), or bis (2-chloroethyl) ether-N,N,N′,N′-tetramethylethylenediamine copolymer).

38. The composition of claim 31 comprising an aqueous system containing haloperoxidase at a concentration in the range of from about 0.01 to about 1000 ppm, a peroxide source that provides hydrogen peroxide at a concentration in the range of from about 0.01 to about 1000 ppm, and a quaternary or polyquaternary ammonium halide at a concentration in the range of from about 0.1 to about 10,000 ppm.

39. The composition of claim 31, comprising an aqueous system containing haloperoxidase at a concentration in the range of from about 0.01 to about 1000 ppm, a quaternary or polyquatemary ammonium halide at a concentration in the range of from about 0.1 to about 10,000 ppm, glucose oxidase at a concentration in the range of from about 0.01 to about 500 ppm and glucose at a concentration in the range of from about 1 to about 10,000 ppm.

40. The composition of claim 39, wherein the composition is maintained in a substantially non-reacting form for a period of time by keeping the glucose oxidase physically separated from the haloperoxidase, glucose and quaternary or polyquaternary ammonium halide.

41. The composition of claim 39, wherein the glucose oxidase is kept under anaerobic conditions.

42. A composition comprising haloperoxidase, a peroxide source, and lysozyme chloride or an enzyme in a halide buffer solution.

43. A method of controlling the growth of algae in or on a product, material, or medium susceptible to attack by algae, the method comprising adding to the product, material, or medium the composition of claim 31.

44. The method of claim 43, wherein the material or medium is in the form of a solid, a dispersion, an emulsion, or a solution.
